(19) United States
(12) Patent Application Publication
(10) Pub. No.: US 2026/0039921 A1
(43) Pub. Date: Feb. 5, 2026

(54) VIDEO-TO-MUSIC MACHINE LEARNING MODEL

(71) Applicant: Lemon Inc., Grand Cayman (KY)

(72) Inventors: Linjie Yang, Los Angeles, CA (US); Yu Tian, Los Angeles, CA (US); Heng Wang, Los Angeles, CA (US); Yan-Bo Lin, Los Angeles, CA (US)

(21) Appl. No.: 18/789,429

(22) Filed: Jul. 30, 2024

(51) Int. Cl. H04N 21/81; H04N 21/439

(52) U.S. Cl. CPC H04N 21/8113; H04N 21/4394

(57) ABSTRACT

A computing system including one or more processing devices configured to receive an input video. At a video-to-music machine learning model including a video encoder and an autoregressive decoder, the one or more processing devices compute video feature tensors at the video encoder based at least in part on the input video. The one or more processing devices autoregressively generate music tokens at the autoregressive decoder based at least in part on the video feature tensors. The video-to-music machine learning model has been trained using a training data set including training input pairs that each include a training input video and training background music. The training also uses a loss function including a video-music contrastive loss term and an autoregressive loss term. The one or more processing devices convert the music tokens into background music associated with the input video. The one or more processing devices output the background music.

### BACKGROUND

Users of video sharing platforms frequently include background music in their videos. When selecting background music for a video, the user may search for pre-produced music that matches a desired mood and tone of the video. The user may also attempt to find pre-produced music in which patterns in the music are aligned in time with particular video events. However, users may sometimes be unable to find any pre-produced music that matches the user's intentions for the video.

### SUMMARY

According to one aspect of the present disclosure, a computing system is provided, including one or more processing devices configured to receive an input video including a plurality of frames. At a video-to-music machine learning model including a video encoder and an autoregressive decoder, the one or more processing devices are further configured to compute a plurality of video feature tensors at the video encoder based at least in part on the input video. The one or more processing devices are further configured to autoregressively generate a plurality of music tokens at the autoregressive decoder based at least in part on the video feature tensors. The video-to-music machine learning model has been trained using a training data set including a plurality of training input pairs that each include a training input video and respective training background music. The training also uses a loss function including a video-music contrastive loss term and an autoregressive loss term. The one or more processing devices are further configured to convert the music tokens into background music associated with the input video. The one or more processing devices are further configured to output the background music.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including one or more processing devices and one or more memory devices at which a video-to-music machine learning model is executed, according to one example embodiment.

FIG. 2 schematically shows the computing system during training of the video-to-music machine learning model, according to the example of FIG. 1.

FIG. 3 schematically shows the computation of a video-music contrastive loss term, according to the example of FIG. 2.

FIG. 4 schematically shows the computation of an autoregressive loss term, according to the example of FIG. 2.

FIG. 5 schematically shows an example architecture of the video-to-music machine learning model, according to the example of FIG. 1.

FIG. 6A shows a flowchart of a method for use with a computing system to generate background music for a video, according to the example of FIG. 1.

FIG. 6B shows additional steps of the method that may be performed to train the video-to-music machine learning model, according to the example of FIG. 6A.

FIGS. 6C-6E show additional steps of the method that may be performed during training of the video-to-music machine learning model, according to the example of FIG. 6B.

FIG. 7 shows plots of data from a human evaluation experiment performed using music generated at the video-to-music machine learning model, according to the example of FIG. 1.

FIG. 8 shows a schematic view of an example computing environment in which the computing system of FIG. 1 may be instantiated.

### DETAILED DESCRIPTION

Since video sharing platform users are sometimes unable to find suitable background music for their videos, as discussed above, some approaches for programmatically generating background music have been developed. Prior video-based music generation approaches typically use symbolic music annotations (e.g., MIDI), which store manually transcribed musical data in a digital format. However, the symbolic annotations used in such approaches have limited expressivity. Such prior techniques therefore do not capture nuances of music such as variations in timbre, articulation, dynamics, and rhythm. The fidelity of the generated music may also be contingent upon the quality of the sound synthesizer or MIDI playback engine, which may not adequately reflect the full depth and complexity of musical instruments. The small scale and limited genre diversity of MIDI annotations also typically lead to poor generalization.

In order to address the above challenges, systems and methods are provided below that utilize a video-to-music machine learning model. The video-to-music machine learning model generates background music for videos in a tokenized form that provides a higher level of detail than typical symbolic music annotations. In addition, the video-to-music machine learning model uses a video-music alignment scheme that temporally matches events in the music to events in the video.

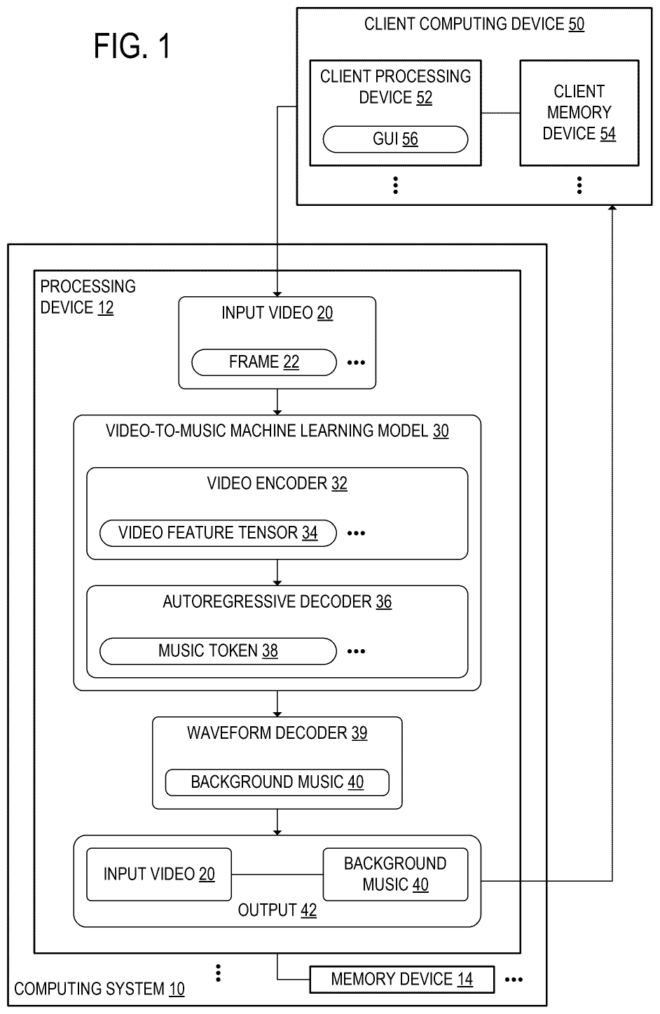

FIG. 1 schematically shows a computing system 10 including one or more processing devices 12 and one or more memory devices 14. The one or more processing devices 12 may, for example, include one or more central processing units (CPUs), graphics processing units (GPUs), tensor units, application-specific integrated circuits (ASICs), and/or other types of processing devices 12. The one or more memory devices 14 may include volatile memory and non-volatile storage.

In some examples, the computing system 10 is distributed across a plurality of physical computing devices, whereas in other examples, the one or more processing devices 12 and the one or more memory devices 14 are included in a single physical computing device. In examples in which the computing system 10 is distributed across multiple physical computing devices, those physical computing devices may, for example, include one or more networked computing devices located at a data center.

FIG. 1 further shows a client computing device 50 that is configured to communicate with the computing system 10. The client computing device 50 includes one or more client processing devices 52 and one or more client memory devices 54. The client computing device 50 may instantiate a client-side user interface of the video sharing platform. This client-side user interface may be a graphical user interface (GUI) 56.

The one or more processing devices 12 included in the computing system 10 are configured to receive an input video 20 including a plurality of frames 22. The input video 20 may be a user-uploaded video received from the client computing device 50. The input video 20 may, for example, structured as a tensor V∈ [symbol] , where tᵥ is the number of frames 22, H is the height in pixels, and W is the width in pixels. The input video 20 has three color channels in this example.

The one or more processing devices 12 are further configured to process the input video 20 at a video-to-music machine learning model 30. FIG. 1 shows the video-to-music machine learning model 30 at inferencing time. The video-to-music machine learning model 30 includes a video encoder 32 and an autoregressive decoder 36. At the video encoder 32, the one or more processing devices 12 are configured to compute a plurality of video feature tensors 34 based at least in part on the input video 20. These video feature tensors 34 may correspond to respective frames 22. At the autoregressive decoder 36, the one or more processing devices 12 are further configured to autoregressively generate a plurality of music tokens 38 based at least in part on the video feature tensors 34.

The one or more processing devices 12 are further configured to convert the music tokens 38 into background music 40 associated with the input video 20. For example, the one or more processing devices 12 may be configured to convert the music tokens 38 into the background music 40 at a waveform decoder 39. Thus, the background music 40 may be computed as a waveform. The one or more processing devices 12 are further configured to output the background music 40. In the example of FIG. 1, the background music 40 is included along with the input video 20 in an output 42 that is transmitted to the client computing device 50. Accordingly, the background music 40 may accompany the input video 20 when the input video 20 is played at the GUI 56. In some examples, the client computing device 50 to which the output 42 is transmitted may differ from the client computing device 50 from which the computing system 10 receives the input video 20. Thus, the input video 20 accompanied by the background music 40 may be shared with other users of the video sharing platform.

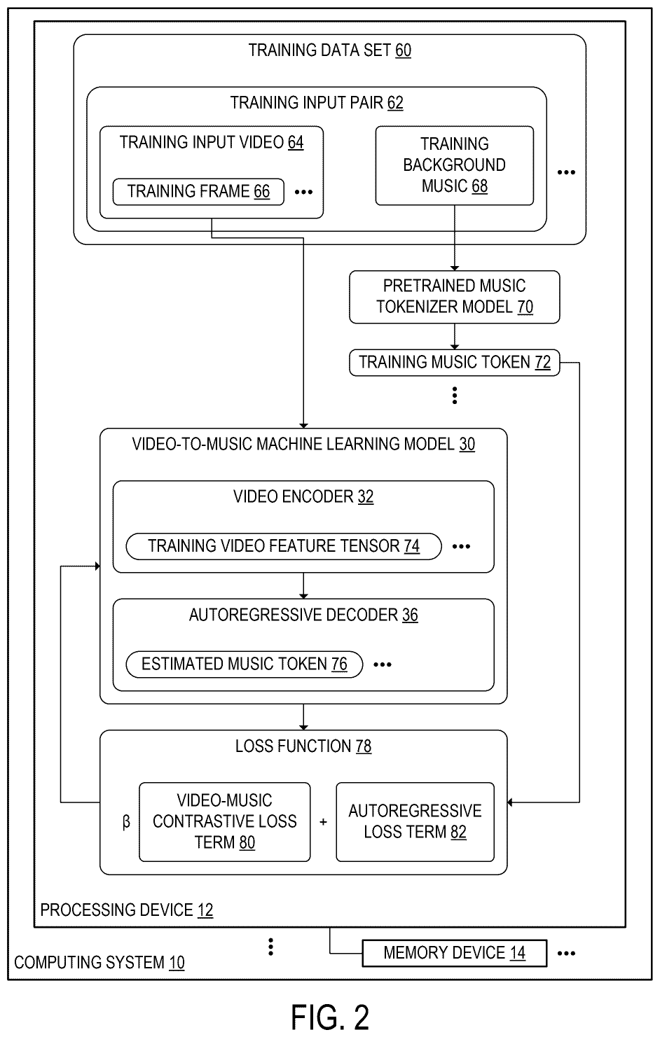

FIG. 2 schematically shows the computing system 10 during training of the video-to-music machine learning model 30. The video-to-music machine learning model 30 is trained using a training data set 60 including a plurality of training input pairs 62. The training input pairs 62 each include a respective training input video 64 and respective training background music 68. The training input video 64 of each training input pair 62 includes a plurality of training frames 66.

The training background music 68 is received as a waveform in the example of FIG. 2. The one or more processing devices 12 are further configured to process the training background music 68 at a pretrained music tokenizer model 70 to obtain a plurality of training music tokens 72. The one or more processing devices 12 are accordingly configured to preprocess the training background music 68 to convert the training background music 68 into a format that matches the outputs of the video-to-music machine learning model 30.

At the video encoder 32, the one or more processing devices 12 are configured to compute a plurality of training video feature tensors 74 based at least in part on the training input videos 64. Based at least in part on the training video feature tensors 74, the one or more processing devices 12 are further configured to compute a plurality of estimated music tokens 76 associated with the training input video 64.

The one or more processing devices 12 are further configured to use the training video feature tensors 74 and estimated music tokens 76 to compute a loss function 78 of the video-to-music machine learning model 30. The computation of the loss function 78 also uses the training music tokens 72 as ground-truth inputs. The loss function 78 includes a video-music contrastive loss term 80 and an autoregressive loss term 82. These terms are weighted with a weighting coefficient β, such that the overall loss function 78 is computed as:

$$ℒ = {βℒ}_{c} + {ℒ}_{g}$$

where [symbol] is the video-music contrastive loss term 80 and [symbol] is the autoregressive loss term 82.

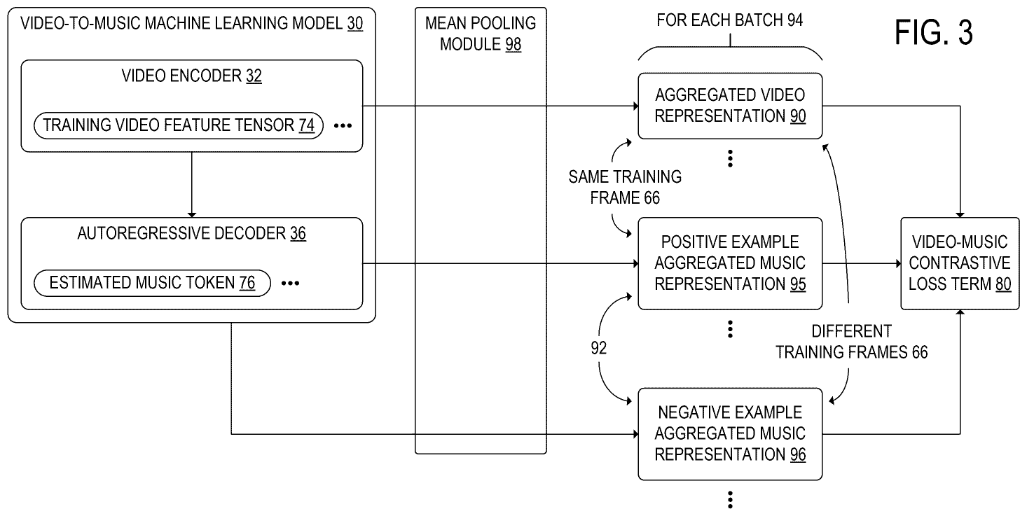

FIG. 3 schematically shows the computation of the video-music contrastive loss term 80. According to the example of FIG. 3, the video-music contrastive loss term 80 is computed for each of the training input videos 64. The one or more processing devices 12 are configured to compute the video-music contrastive loss term 80 between aggregated video representations 90 of the training video feature tensors 74 and aggregated music representations 92 of the estimated music tokens 76.

The video-music contrastive loss term 80 may be computed for each batch 94 of the plurality of training input. Within a batch 94, The aggregated video representations 90 are paired with corresponding aggregated music representations 92 associated with training frames 66 of the training input video 64. The plurality of aggregated music representations 92 include a plurality of positive example aggregated music representations 95 and a plurality of negative example aggregated music representations 96. The associated training frames 66 of the positive example aggregated music representations 95 match those of the aggregated video representations 90, whereas the associated training frames 66 of the negative example aggregated music representations 96 mismatch those of the aggregated video representations 90.

The aggregated video representations 90 are computed at least in part by applying mean pooling to the training video feature tensors 74 computed from the training input videos 64 at the video encoder 32. As shown in the example of FIG. 3, the one or more processing devices 12 are configured to execute a mean pooling module 98 that applies temporal mean pooling. At the mean pooling module 98, the one or more processing devices 12 are further configured to apply temporal mean pooling to estimated music tokens 76 predicted at the video-to-music machine learning model 30 to compute the aggregated music representations 92.

When the one or more processing devices 12 compute the video-music contrastive loss term 80, the one or more processing devices 12 are configured to compute matrices of music features as M=ŶE. In this equation, Ŷ∈

$${ℝ}^{{t}_{a} \times c}$$

are the estimated music tokens 76, where tₐ is the number of music timesteps and c is a number of discrete categories corresponding to ranges of audio frequencies. In addition, E∈

$${ℝ}^{c \times d}$$

is an embedding matrix of the pretrained music tokenizer model 70, where d is a channel dimension. Accordingly, the matrix of music features M has dimensions tₐ×d. The training video feature tensor 74 may be expressed as Xᵥ∈

$${ℝ}^{{t}_{v} / 2 \times d}$$

, where tᵥ is the number of training frames 66. Applying mean pooling to the music features M and the training video feature tensor Xᵥ results in an aggregated music representation M̅∈

$${ℝ}^{d}$$

and an aggregated video representation Xᵥ∈

$${ℝ}^{d}$$

The one or more processing devices 12 are configured to compute the video-music contrastive loss term 80 as follows:

$${ℒ}_{c} = - \frac{1}{B} {\sum }_{i = 1}^{B} log \frac{exp ( g ( {\overline{X}}_{v} ( i ) , \overline{M} ( i ) ) )}{{\sum }_{j = 1}^{B} exp ( g ( {\overline{X}}_{v} ( i ) , \overline{M} ( j ) ) )}$$

In the above equation, g(x, y) is cosine similarity and B is the batch size. The positive example aggregated music representations 95 are M̅(i); the negative example aggregated music representations 96 are the aggregated music representations M̅(j) for j≠i.

The video-music contrastive loss term 80 may guide the training process of the video-to-music machine learning model 30 to match high-level video cues (e.g., genre and style) of the training input videos 64 to the generated music. This matching may be achieved by using temporal mean pooling to encode high-level features of the training input videos 64 and generated music across their entire durations, as well as by contrasting matched and mismatched video and music in the video-music contrastive loss term 80.

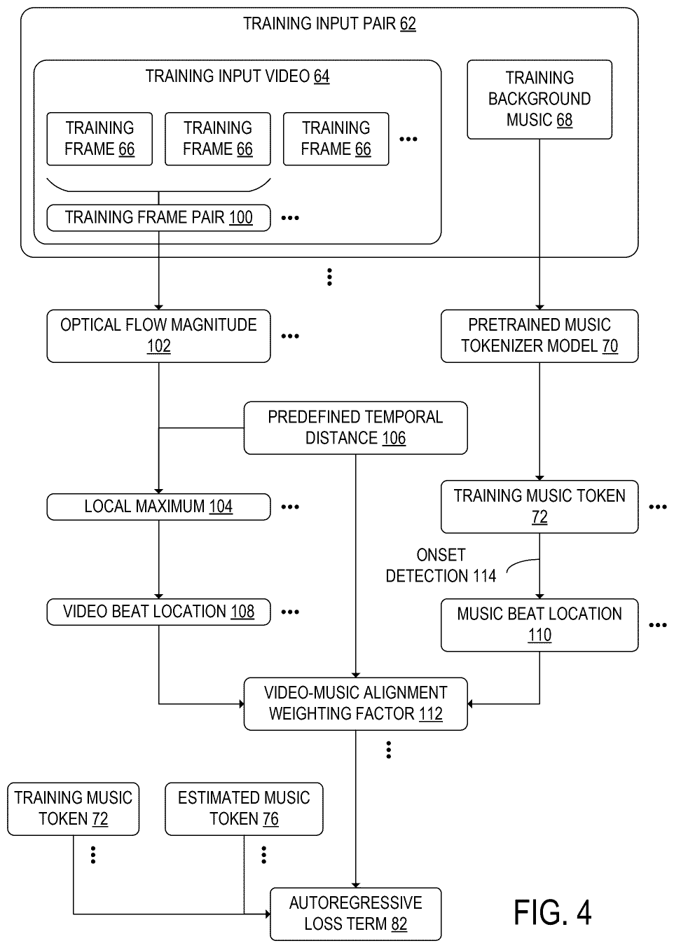

FIG. 4 schematically shows the computation of the autoregressive loss term 82, according to one example. In the example of FIG. 4, the autoregressive loss term 82 includes a video-music alignment weighting factor 112 that is computed for each of the training input pairs 62.

Computing the video-music alignment weighting factor 112 for a training input pair 62 includes computing a plurality of music beat locations 110 within the training background music 68 included in that training input pair 62. The music beat locations 110 are points in time at which beats occur in the training background music 68. Computing the music beat locations 110 includes processing the training background music 68 at the pretrained music tokenizer model 70 to obtain a plurality of training music tokens 72. Computing the music beat locations 110 further includes performing onset detection 114 on the training music tokens 72 to identify the music beat locations 110.

Computing the video-music alignment weighting factor 112 further includes computing a plurality of video beat locations 108 within the training input video 64. The video beat location 108 are points in time at which significant changes (e.g., scene transitions or dance motions) in the training input video 64 occur. In the example of FIG. 4, the video beat locations 108 are computed at least in part by computing a plurality of optical flow magnitudes 102 of respective training frame pairs 100 included in the training input video 64. The training frame pairs are pairs of successive training frames 66. The one or more processing devices 12 are further configured to compute the video beat locations 108 within the training input video 64 based at least in part on the optical flow magnitudes 102. For example, the video beat locations 108 may be local maxima of the optical flow magnitudes 102. In such examples, a training frame 66 within the training input video 64 may be identified as a local maximum by determining that it has the highest optical flow magnitude 102 among the training frame 66 within a predefined temporal distance 106. Thus, the one or more processing devices may be configured to identify training frames 66 at which significant amounts of change, as measured by the optical flow magnitudes 102, occur in the training input video 64.

The one or more processing devices 12 are further configured to compute the video-music alignment weighting factor 112 based at least in part on the music beat locations 110 and the video beat locations 108. In the example of FIG. 4, the one or more processing devices 12 are configured to compute the video-music alignment weighting factor 112 at least in part by determining whether, for each of the video beat locations 108, the training background music 68 includes a music beat location 110 within a predefined temporal distance 106 of that video beat location 108. The predefined temporal distance 106 used to compute the video-music alignment weighting factor 112 may be the same predefined temporal distance 106 used to identify the video beat locations 108. In other examples, some other predefined temporal distance may be used instead.

During computation of the autoregressive loss term 82, the music beat locations 110 may be indicated in a vector Pₐ∈ [symbol] , where Pₐ[t] is set to 1 if a music beat is detected at timestep t. Otherwise, Pₐ[t] is set to 0. The optical flow magnitudes 102 may be indicated in a vector O∈ [symbol] , which is linearly interpolated to match the dimension of the music beat locations Pₐ. The video beat locations 108 may be indicated in a vector Pᵥ∈ [symbol] . In this vector, Pᵥ[t] is set to 1 for each timestep t at which O[t] is the maximum optical flow value within a temporal window of O[t−δ:t+δ], where δ is the predefined temporal distance 106. Otherwise, Pᵥ[t] may be set to 0.

The one or more processing devices 12 are further configured to computed the video-music alignment weighting factor 112 as the overlap between the music beat locations 110 and the video beat locations 108:

$${P}_{av} [ i ] = \{ \begin{matrix}1 if {P}_{v} [ i ] = 1 and {\sum }_{j = - δ}^{δ} {P}_{a} [ i + j ] > 0 \\ α else\end{matrix}$$

In the above equation, α is a hyperparameter that is used to prevent the timesteps without overlapping music beat locations 110 and video beat locations 108 from being disproportionately de-emphasized during training. Using the above equation, the one or more processing devices 12 are configured to check whether the video beats Pᵥ[i] match the music beats in a window Pₐ[i−δ:i+δ].

The one or more processing devices 12 are further configured to compute the autoregressive loss term 82 as follows:

$${ℒ}_{g} = - {\sum }_{i = 1}^{c} {P}_{av} {Y}_{i} log ( {\hat{Y}}_{i} )$$

In the above equation, Yᵢ are the training music tokens 72 that are used as ground-truth music tokens. Ŷᵢ are the estimated music tokens 76 generated at the video-to-music machine learning model 30. The above equation reduces to a uniformly weighted autoregressive objective function if the values of Pₐᵥ are all set to 1. Using the above formulation of the autoregressive loss term 82, the video-music alignment weighting factors 112 are used to guide the video-to-music machine learning model 30 to generate music beats that are aligned with the low-level visual content of the training input videos 64, as indicated by the video beat locations 108.

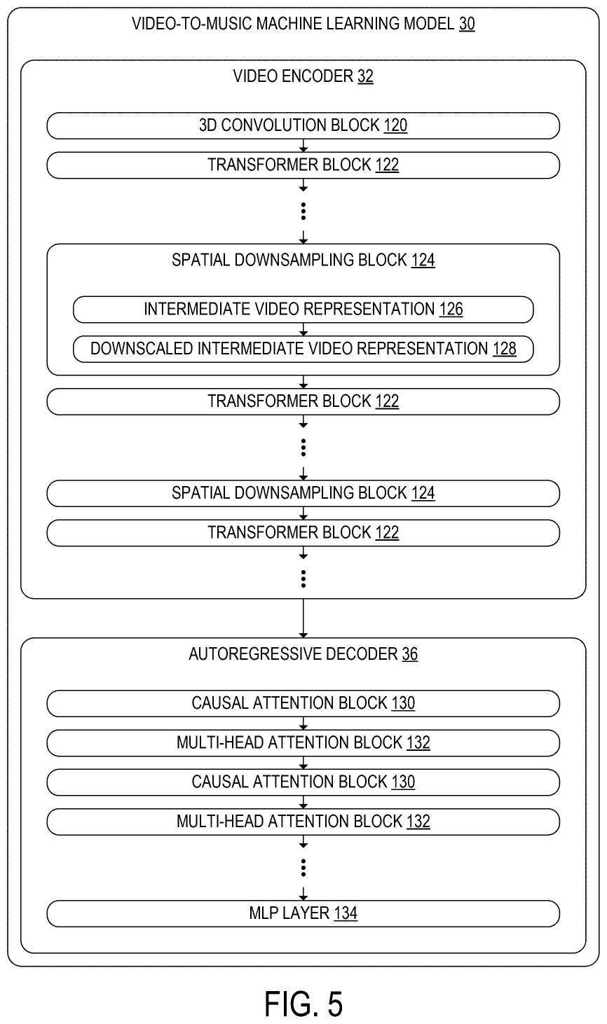

FIG. 5 schematically shows an example architecture of the video-to-music machine learning model 30 in additional detail. According to the example of FIG. 5, the video encoder 32 includes a three-dimensional (3D) convolution block 120 followed by a plurality of transformer blocks 122. The video encoder 32 further includes a plurality of spatial downsampling blocks 124. At each of the spatial downsampling blocks 124, the one or more processing devices 12 are configured to spatially downscale a respective intermediate video representation 126 computed at the video encoder 32 to obtain a corresponding downscaled intermediate video representation 128. The downscaled intermediate video representation 128 is passed to a subsequently layer of the video encoder 32. In the example of FIG. 5, the spatial downsampling blocks 124 are interspersed among the transformer blocks 122.

The following table summarizes the properties of the 3D convolution block 120 and the spatial downsampling blocks 124. In this example, respective spatial downsampling blocks 124 are included after the 2^{nd}, 5^{th}, 21^{st}, and 24^{th} transformer blocks 122 of the video encoder 32. In this table, T is a temporal dimension, S is a width and height, and D is a feature length.

| Stage | Architecture details | Output sizes T × S² × D |
|---|---|---|
| Video input | N/A | 96 × 3 × 2242 |
| 3D Conv | Kernel 3 × 72 | 48 × 562 × 96 |
| | Stride 2 × 42 | |
| | Padding 1 × 32 | |
| Pooling strides at 2^{nd} | 1 × 4 × 4 | 48 × 142 × 192 |
| Pooling strides at 5^{th} | 1 × 7 × 7 | 48 × 22 × 384 |
| Pooling strides at 21^{st} | 1 × 2 × 2 | 48 × 12 × 768 |
| Pooling strides at 24^{th} | 1 × 1 × 1 | 48 × 12 × 768 |

FIG. 5 further shows the autoregressive decoder 36. In the example of FIG. 5, the autoregressive decoder 36 includes a plurality of causal attention blocks 130 alternating with a plurality of multi-head attention blocks 132. The autoregressive decoder 36 receives video features Xᵥ and quantized music tokens

$${X}_{a}^{( 0 )}$$

as inputs. The operations performed at the autoregressive decoder 36 may be expressed as follows:

$${F}^{( l )} = CA ( {X}_{a}^{( l - 1 )} , {X}_{a}^{( l - 1 )} , {X}_{a}^{( l - 1 )} ) + {X}_{a}^{( l - 1 )}$$

$${X}_{a}^{( l )} = MHA ( {F}^{( l )} , {X}_{v} , {X}_{v} ) + {F}^{( l )}$$

In the above equations, CA(⋅) and MHA(⋅) are the causal attention block 130 and a multi-head attention block 132, respectively. In addition, l indicates a layer number and F^{(l)}∈ [symbol] is an intermediate music representation computed from music tokens

$${X}_{a}^{( l - 1 )} .$$

The one or more processing devices 12 are configured to feed the video features Xᵥ into each of the multi-head attention blocks 132 as contextual features. The new music token representation

$${X}_{a}^{( l )}$$

at layer l is computed at a multi-head attention block 132 that uses the intermediate music representation F^{(l)} as the query and the video features Xᵥ as the keys and values. The autoregressive decoder 36 further includes a multi-layer perceptron (MLP) layer 134 that computes the final music output Ŷ∈ [symbol] . Thus, the autoregressive decoder 36 is configured to compute the music tokens 38 that are post-processed to obtain the background music 40.

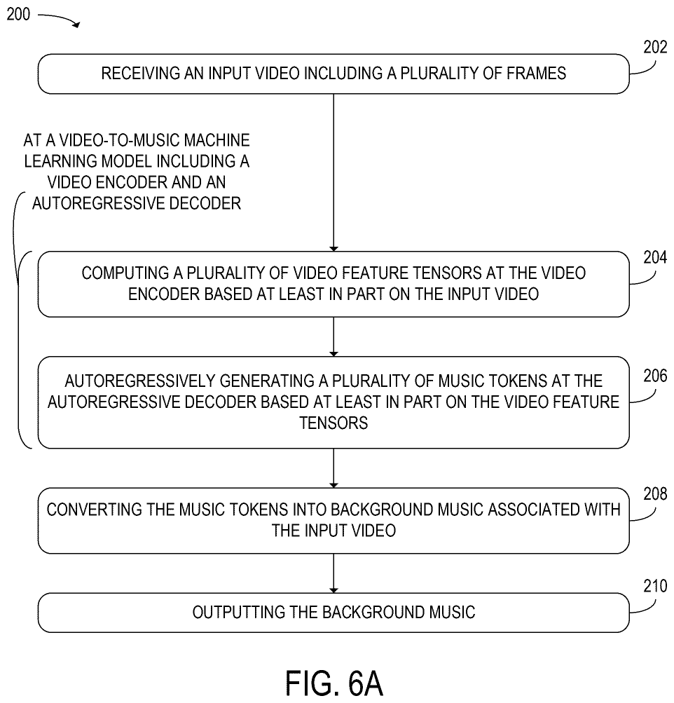

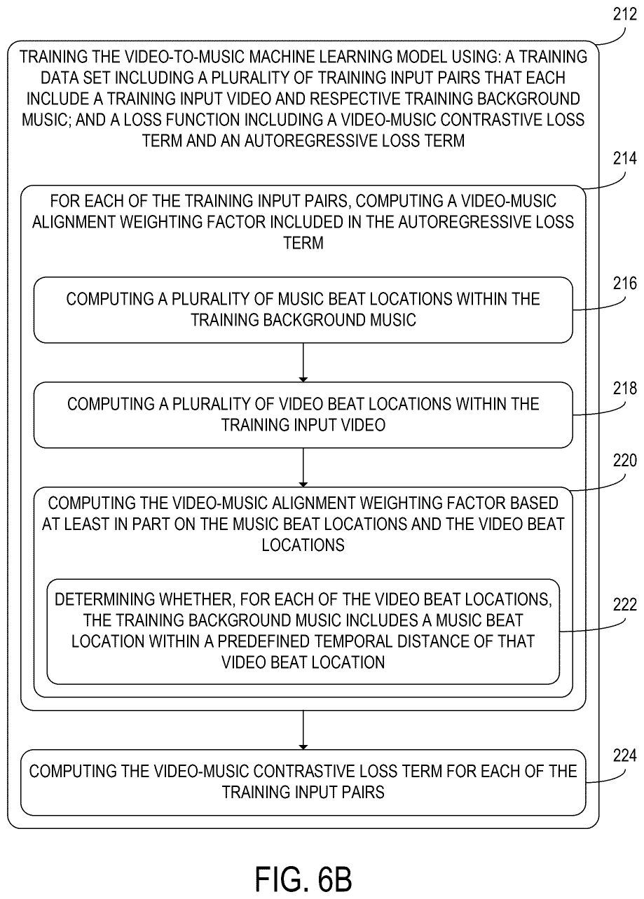

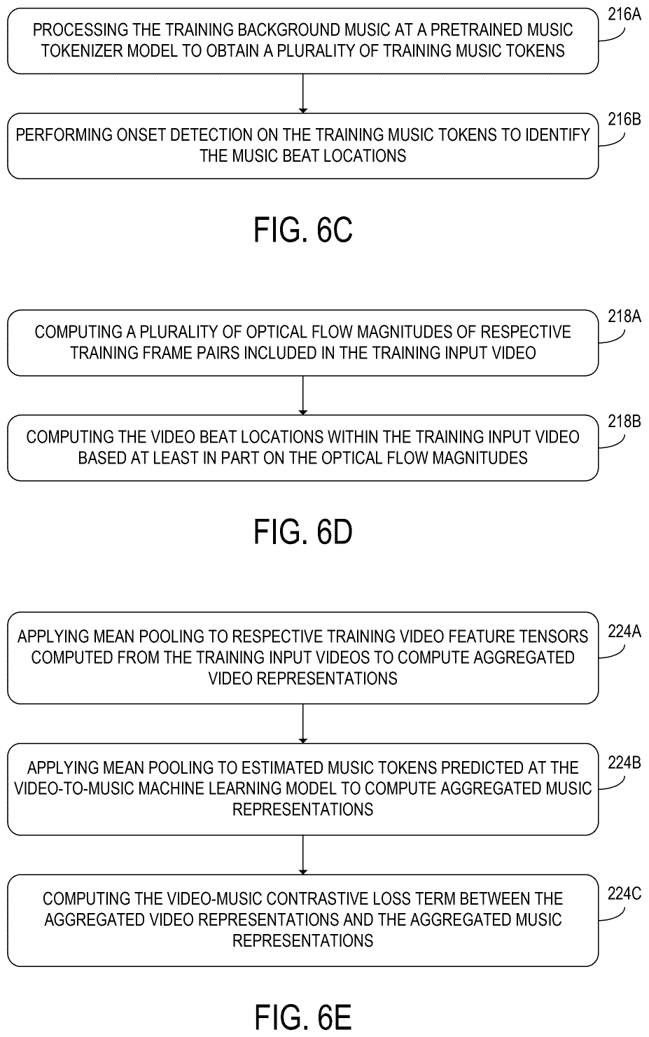

FIG. 6A shows a flowchart of a method 200 for use with a computing system to generate background music for a video. At step 202, the method 200 includes receiving an input video including a plurality of frames. For example, the input video may be received from a client computing device as a video uploaded to a video sharing platform.

Steps 204 and 206 of the method 200 are performed at a video-to-music machine learning model including a video encoder and an autoregressive decoder. At step 204, the method 200 further includes computing a plurality of video feature tensors at the video encoder based at least in part on the input video. The video encoder may include a 3D convolution block and a plurality of transformer blocks. In addition, the video encoder may include a plurality of spatial downsampling blocks interspersed among the transformer blocks. At each of the spatial downsampling blocks, computing the video feature tensors at step 204 may include spatially downscaling a respective intermediate video representation computed at the video encoder.

At step 206, the method 200 further includes autoregressively generating a plurality of music tokens at the autoregressive decoder based at least in part on the video feature tensors. The autoregressive decoder may include a plurality of causal attention blocks alternating with a plurality of multi-head attention blocks. Following the causal attention blocks and the multi-head attention blocks, the autoregressive decoder may further include an MLP layer that outputs the music tokens.

At step 208, the method 200 further includes converting the music tokens into background music associated with the input video. At step 210, the method 200 further includes outputting the background music. The background music may be output along with the input video to a client computing device.

FIGS. 6B-6E show additional steps of the method 200 that may be performed during training of the video-to-music machine learning model, prior to step 202. FIG. 6B shows step 212, at which the method 200 further includes training the video-to-music machine learning model using a training data set including a plurality of training input pairs. The training input pairs each include a training input video and respective training background music. In addition, the training process of the video-to-music machine learning model further utilizes a loss function including a video-music contrastive loss term and an autoregressive loss term.

As shown in FIG. 6B, training the video-to-music machine learning model at step 212 may include performing step 214. At step 214, the method 200 may further include computing a video-music alignment weighting factor included in the autoregressive loss term for each of the training input pairs. Computing the video-music alignment weighting factor at step 214 may include, at step 216, computing a plurality of music beat locations within the training background music. The music beat locations are timesteps at which beats are estimated to occur in the training background music.

FIG. 6C shows additional steps that may be performed to identify the music beat locations. At step 216A, step 216 may include processing the training background music at a pretrained music tokenizer model to obtain a plurality of training music tokens. At step 216B, step 216 may further include performing onset detection on the training music tokens to identify the music beat locations.

Returning to FIG. 6B, computing the video-music alignment weighting factor at step 214 may further include computing a plurality of video beat locations within the training input video. The video beat locations are timesteps at which significant changes (e.g., scene changes or dance motions) are estimated to occur in the training input videos.

FIG. 6D shows additional steps of the method 200 that may be performed to compute the video beat locations. At step 218A, step 218 may include computing a plurality of optical flow magnitudes of respective training frame pairs included in the training input video. At step 218B, step 218 may further include computing the video beat locations within the training input video based at least in part on the optical flow magnitudes. The video beat locations may be computed as local maxima of the optical flow magnitudes, within a predefined temporal distance before and after each timestep identified as a video beat location.

Returning to FIG. 6B, computing the autoregressive loss term may further include, at step 220, computing the video-music alignment weighting factor based at least in part on the music beat locations and the video beat locations. For each of the video beat locations, step 220 may include, at step 222, determining whether the training background music includes a music beat location within a predefined temporal distance of that video beat location. In some examples, step 222 may use the same predefined temporal distance that is used to identify the video beat locations at step 218B.

At step 224, training the video-to-music machine learning model may further include computing the video-music contrastive loss term for each of the training input pairs. FIG. 6E shows additional steps of the method 200 that may be performed in some examples to compute the video-music contrastive loss term. At step 224A, step 224 may include applying mean pooling to respective training video feature tensors computed from the training input videos. Accordingly, aggregated video representations may be computed. At step 224B, step 224 may further include applying mean pooling to estimated music tokens predicted at the video-to-music machine learning model. Accordingly, aggregated music representations may be computed. At step 224C, step 224 may further include computing the video-music contrastive loss term between the aggregated video representations and the aggregated music representations. Computing the video-music contrastive loss term may include comparing positive example aggregated music representations to negative example aggregated music representations. The associated training frames of the positive example aggregated music representations match those of the aggregated video representations, whereas the training frames of the negative example aggregated music representations are mismatched with those of the aggregated video representations.

Using the video-music contrastive loss term and the autoregressive loss term, the video-to-music machine learning model is trained to generate background music that matches the input video in terms of high-level features such as genre, while also having music beats that are aligned with events that occur within the input video. The generated background music may accordingly reflect the contents of the input video more closely than background music generated with previous video-to-music generation techniques.

Experiments that tested the above systems and methods are discussed below. In these experiments, the video-to-music machine learning model was trained using a training dataset (DISCO-MV) of approximately 2.28 million video-music samples. 1120 validation pairs and 1086 testing pairs were also used in the experiments. The MusicCaps dataset, which includes 2858 captioned music samples, was also used to evaluate the models in the experiments discussed below.

Fréchet Audio Distance (FAD) was used as one of the evaluation metrics. FAD measures a distance between the distribution of the generated music and the reference music in a pretrained VGGish feature space. KL divergence (KL) was also used as an evaluation metric. The KL divergence was computed using a music genre tagging model that was pretrained on the Million Song dataset and was used to measure the divergence of the output distributions from the reference music. Music-video alignment was also used as an evaluation metric.

The video-to-music machine learning model discussed above, referred to here as the Video-Music Alignment Scheme (VMAs) model, was compared to several existing video-to-music models. These models included Controllable Music Transformer (CMT), Video2Music, VidMusicGen, Vid2MLDM, and V2Meow. The results of these comparisons are shown in the following table:

| | MusicCaps | | | DISCO- | | |
|---|---|---|---|---|---|---|
| | Test Set | | MV | MV | | MV |
| | FAD | KL | Align | FAD | KL | Align |
| Method | (↓) | (↓) | (↑) | (↓) | (↓) | (↑) |
| CMT | 16.2 | 1.42 | 0.18 | 3.70 | 1.82 | 0.34 |
| Video2Music | 24.7 | 1.35 | 0.19 | 4.36 | 1.93 | 0.29 |
| VidMusicGen | 6.91 | 1.26 | 0.17 | 2.93 | 1.60 | 0.25 |
| Vid2MLDM | 8.99 | 1.15 | 0.20 | 3.21 | 1.41 | 0.32 |
| V2Meow | 4.62 | — | — | — | — | — |
| VMAs | 4.07 | 1.09 | 0.22 | 2.38 | 1.34 | 0.35 |

As shown in the above table, VMAs outperforms the previous models on all three evaluation criteria and on both evaluation sets.

Since the source code of V2Meow has not been released, the table discussed above does not include evaluation scores for V2Meow on most of the evaluation metrics. To obtain a closer comparison between VMAs and V2Meow, an instance of VMAs was trained on the same dataset used to train V2Meow. The following table shows comparisons between V2Meow and both versions of VMAs:

| | Training | Num. of | | |
|---|---|---|---|---|
| Method | Dataset | Videos | FAD (↓) | KL (↓) |
| V2Meow | MV100K | 100K | 4.62 | 1.22 |
| VMAs | MV100K | 100K | 4.51 | 1.15 |
| VMAs | DISCO-MV | 2.2M | 4.07 | 1.10 |

As shown in the above table, VMAs outperforms V2Meow even when trained on the smaller MV100K dataset that was used to train V2Meow.

Human evaluation experiments were also performed to compare VMAs to CMT, Video2Music, VidMusicGen, and Vid2MLDM. In these experiments, the evaluators were asked to select their preferred video-music samples based on 1) the overall music generation quality, and 2) the alignment between the generated music and its corresponding video. Specifically, given a pair of video-music samples, where the video was the same but the music is generated by two different methods, the evaluators were asked to select a preferred video-music sample based on the following prompts: 1) “Which music video has higher overall quality music?” and 2) “Which music video has better synchronization between music and visual content?” For each question, the evaluators chose between one of the two methods or a third option, “Cannot tell.” Each evaluator performed 10 evaluations for a given pair of methods, which were hidden from the evaluators. 200 different evaluators ranked the video-music samples in the human evaluation experiment.

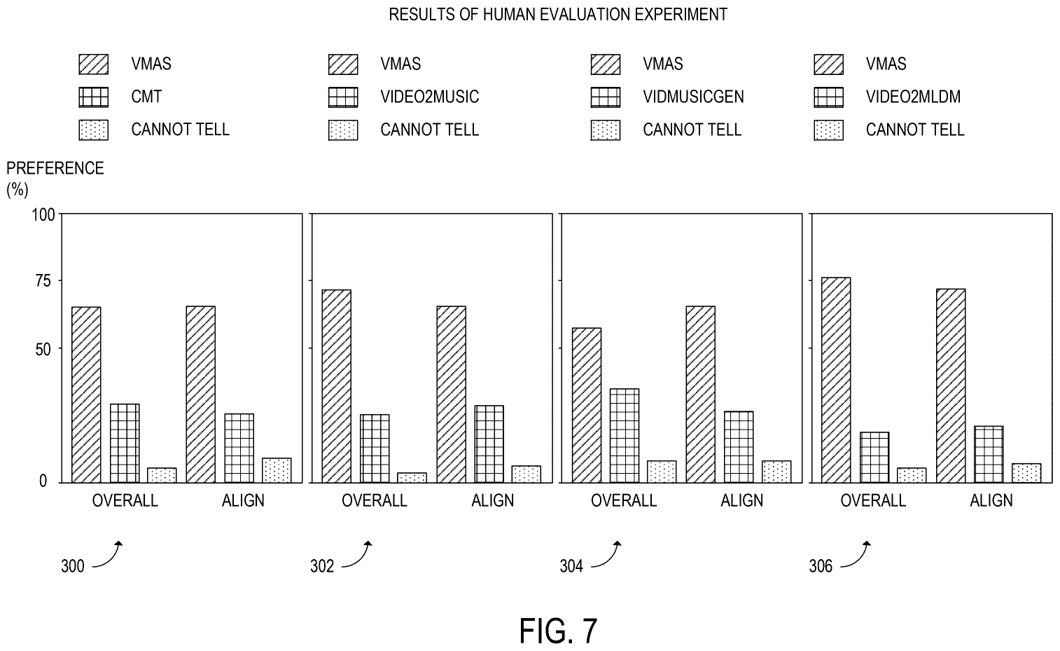

FIG. 7 shows plots 300, 302, 304, and 306 of data from the human evaluation experiment. The plot 300 compares the evaluations of VMAs and CMT, the plot 302 compares the evaluations of VMAs and Video2Music, the plot 304 compares the evaluations of VMAs and VidMusicGen, and the plot 306 compares the evaluations of VMAs and Video2MLDM. As shown in each of these plots, the human evaluators typically preferred VMAs to the previous approaches in both overall quality and video-music alignment. On average, the evaluators preferred VMAs over 70% of the time for overall music generation quality and 67% of the time for video-music alignment.

Ablation studies were also performed to measure the contributions of the video-music contrastive loss term and the video-music alignment weighting factor to the performance of VMAs. The following table compares versions of VMAs trained using each of these techniques to an autoregressive baseline that did not use either:

| Configuration | FAD (↓) | KL (↓) | MV Align (↑) |
|---|---|---|---|
| Autoregressive | 2.75 | 1.40 | 0.243 |
| Baseline | | | |
| +Video-Music | 2.40 | 1.34 | 0.251 |
| Contrastive | | | |
| +Video-Beat | 2.38 | 1.34 | 0.342 |
| Alignment | | | |

The above table shows that both the video-music contrastive loss term and the video-music alignment weighting factor improve performance on all three evaluation metrics compared to the autoregressive baseline.

Another experiment compared the performance of the VMAs video encoder to the existing video encoders CLIP and Hiera. These encoders were tested on DISCO-MV dataset using FAD, KL, and MV Align as evaluation metrics. The encoders were also evaluated based on training compute expenditure (GFLOPS). The following table shows the results of these comparisons:

| Video | | | | MV Align | GFLOPS |
|---|---|---|---|---|---|
| Encoder | #Frames | FAD (↓) | KL (↓) | (↑) | (↓) |
| CLIP | 16 | 2.61 | 1.41 | 0.274 | 281.6 |
| Hiera | 16 | 2.58 | 1.41 | 0.316 | 140.2 |
| VMAs | 96 | 2.38 | 1.34 | 0.342 | 130.7 |

The above table shows that the VMAs encoder outperforms both CLIP and Hiera on FAD, KL, and MV Align while also being less expensive to train.

Another experiment tested the effects of different training dataset sizes on the FAD scores of VMAs. The following table summarizes the results of this experiment:

| Dataset | % of total size | FAD (↓) |
|---|---|---|
| MusicCaps | 10 | 4.7 |
| | 25 | 4.4 |
| | 50 | 4.3 |
| | 100 | 4.1 |
| DISCO-MV | 10 | 3.2 |
| | 25 | 2.9 |
| | 50 | 2.7 |
| | 100 | 2.4 |

The methods and processes described herein are tied to a computing system of one or more computing devices. In particular, such methods and processes can be implemented as a computer-application program or service, an application-programming interface (API), a library, and/or other computer-program product.

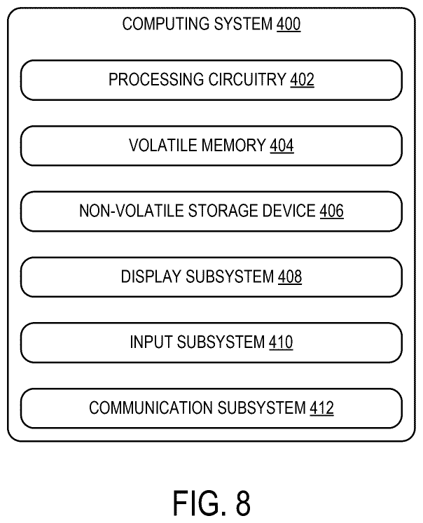

FIG. 8 schematically shows a non-limiting embodiment of a computing system 400 that can enact one or more of the methods and processes described above. Computing system 400 is shown in simplified form. Computing system 400 may embody the computing system 10 described above and illustrated in FIG. 1. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 8.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system 400 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory 404, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device 406, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local-or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive an input video including a plurality of frames. At a video-to-music machine learning model including a video encoder and an autoregressive decoder, the one or more processing devices are further configured to compute a plurality of video feature tensors at the video encoder based at least in part on the input video. The one or more processing devices are further configured to autoregressively generate a plurality of music tokens at the autoregressive decoder based at least in part on the video feature tensors. The video-to-music machine learning model has been trained using a training data set including a plurality of training input pairs that each include a training input video and respective training background music. The training further utilizes a loss function including a video-music contrastive loss term and an autoregressive loss term. The one or more processing devices are further configured to convert the music tokens into background music associated with the input video. The one or more processing devices are further configured to output the background music. The above features may have the technical effect of generating background music that matches the input video in high-level features such as genre while also matching beats in the background music to visual events in the input video.

According to this aspect, the autoregressive loss term may include a video-music alignment weighting factor that is computed for each of the training input pairs at least in part by computing a plurality of music beat locations within the training background music, computing a plurality of video beat locations within the training input video, and computing the video-music alignment weighting factor based at least in part on the music beat locations and the video beat locations. The above features may have the technical effect of training the video-to-music machine learning model to match the music beat locations to the video beat locations when generating background music.

According to this aspect, the video beat locations may be computed at least in part by computing a plurality of optical flow magnitudes of respective training frame pairs included in the training input video. Computing the video beat locations may further include computing the video beat locations within the training input video based at least in part on the optical flow magnitudes. The above features may have the technical effect of identifying the video beat locations according to the amount of change in the input video.

According to this aspect, the video beat locations may be local maxima of the optical flow magnitudes. The above feature may have the technical effect of identifying the video beat locations.

According to this aspect, the one or more processing devices may be configured to compute the video-music alignment weighting factor at least in part by determining whether, for each of the video beat locations, the training background music includes a music beat location within a predefined temporal distance of that video beat location. The above features may have the technical effect of determining how closely the music beat locations match the video beat locations.

According to this aspect, the one or more processing devices may be configured to compute the music beat locations at least in part by processing the training background music at a pretrained music tokenizer model to obtain a plurality of training music tokens. Computing the music beat locations may further include performing onset detection on the training music tokens to identify the music beat locations. The above features may have the technical effect of identifying the music beat locations in the training background music.

According to this aspect, the video-music contrastive loss term may be computed between aggregated video representations computed by applying mean pooling to respective training video feature tensors computed from the training input videos and aggregated music representations computed by applying mean pooling to estimated music tokens predicted at the video-to-music machine learning model. The above features may have the technical effect of training the video-to-music machine learning model to match high-level features of the generated background music to high-level features of the input video.

According to this aspect, the video encoder may include a plurality of spatial downsampling blocks. At each of the spatial downsampling blocks, the one or more processing devices may be configured to spatially downscale a respective intermediate video representation computed at the video encoder. The above features may have the technical effect of encoding a spatially compressed representation of the input video for processing at the autoregressive decoder.

According to this aspect, the spatial downsampling blocks may be interspersed among a plurality of transformer blocks. The above features may have the technical effect of computing the intermediate video representations that are downscaled at the spatial downsampling blocks.

According to this aspect, the autoregressive decoder may include a plurality of causal attention blocks alternating with a plurality of multi-head attention blocks. The above feature may have the technical effect of representing the temporal structure of the music generated at the autoregressive decoder.

According to another aspect of the present disclosure, a method for use with a computing system is provided. The method includes receiving an input video including a plurality of frames. At a video-to-music machine learning model including a video encoder and an autoregressive decoder, the method further includes computing a plurality of video feature tensors at the video encoder based at least in part on the input video. The method further includes autoregressively generating a plurality of music tokens at the autoregressive decoder based at least in part on the video feature tensors. The video-to-music machine learning model has been trained using a training data set including a plurality of training input pairs that each include a training input video and respective training background music. The training further utilizes a loss function including a video-music contrastive loss term and an autoregressive loss term. The method further includes converting the music tokens into background music associated with the input video. The method further includes outputting the background music. The above features may have the technical effect of generating background music that matches the input video in high-level features such as genre while also matching beats in the background music to visual events in the input video.

According to this aspect, the autoregressive loss term may include a video-music alignment weighting factor that is computed for each of the training input pairs at least in part by computing a plurality of music beat locations within the training background music, computing a plurality of video beat locations within the training input video, and computing the video-music alignment weighting factor based at least in part on the music beat locations and the video beat locations. The above features may have the technical effect of training the video-to-music machine learning model to match the music beat locations to the video beat locations when generating background music.

According to this aspect, computing the video beat locations may include computing a plurality of optical flow magnitudes of respective training frame pairs included in the training input video. Computing the video beat locations may further include computing the video beat locations within the training input video based at least in part on the optical flow magnitudes. The above features may have the technical effect of identifying the video beat locations according to the amount of change in the input video.

According to this aspect, the video beat locations may be local maxima of the optical flow magnitudes. The above feature may have the technical effect of identifying the video beat locations.

According to this aspect, computing the video-music alignment weighting factor may include determining whether, for each of the video beat locations, the training background music includes a music beat location within a predefined temporal distance of that video beat location. The above features may have the technical effect of determining how closely the music beat locations match the video beat locations.

According to this aspect, computing the music beat locations may include processing the training background music at a pretrained music tokenizer model to obtain a plurality of training music tokens. Computing the music beat locations may further include performing onset detection on the training music tokens to identify the music beat locations. The above features may have the technical effect of identifying the music beat locations in the training background music.

According to this aspect, the video-music contrastive loss term may be computed between aggregated video representations computed by applying mean pooling to respective training video feature tensors computed from the training input videos and aggregated music representations computed by applying mean pooling to estimated music tokens predicted at the video-to-music machine learning model. The above features may have the technical effect of training the video-to-music machine learning model to match high-level features of the generated background music to high-level features of the input video.

According to this aspect, the video encoder may include a plurality of spatial downsampling blocks. At each of the spatial downsampling blocks, the method may further include spatially downscaling a respective intermediate video representation computed at the video encoder. The above features may have the technical effect of encoding a spatially compressed representation of the input video for processing at the autoregressive decoder.

According to this aspect, the autoregressive decoder may include a plurality of causal attention blocks alternating with a plurality of multi-head attention blocks. The above feature may have the technical effect of representing the temporal structure of the music generated at the autoregressive decoder.

According to another aspect of the present disclosure, a computing system is provided, including one or more processing devices configured to train a video-to-music machine learning model. The video-to-music machine learning model may include a video encoder and an autoregressive decoder. The video-to-music machine learning model may be trained using a training data set including a plurality of training input pairs that each include a training input video and respective training background music. The training further utilizes a loss function including a video-music contrastive loss term and an autoregressive loss term. The autoregressive loss term includes a video-music alignment weighting factor that is computed for each of the training input pairs at least in part by computing a plurality of music beat locations within the training background music, computing a plurality of video beat locations within the training input video, and computing the video-music alignment weighting factor based at least in part on the music beat locations and the video beat locations. The video-music contrastive loss term is computed between aggregated video representations computed by applying mean pooling to respective training video feature tensors computed from the training input videos and aggregated music representations computed by applying mean pooling to estimated music tokens predicted at the video-to-music machine learning model.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein. as well as any and all equivalents thereof.

1. A computing system comprising:
one or more processing devices configured to:
receive an input video including a plurality of frames;
at a video-to-music machine learning model including a video encoder and an autoregressive decoder:
compute a plurality of video feature tensors at the video encoder based at least in part on the input video; and
autoregressively generate a plurality of music tokens at the autoregressive decoder based at least in part on the video feature tensors, wherein the video-to-music machine learning model has been trained using:
a training data set including a plurality of training input pairs that each include a training input video and respective training background music; and
a loss function including a video-music contrastive loss term and an autoregressive loss term;
convert the music tokens into background music associated with the input video; and
output the background music.

2. The computing system of claim 1, wherein the autoregressive loss term includes a video-music alignment weighting factor that is computed for each of the training input pairs at least in part by:
computing a plurality of music beat locations within the training background music;
computing a plurality of video beat locations within the training input video; and
computing the video-music alignment weighting factor based at least in part on the music beat locations and the video beat locations.

3. The computing system of claim 2, wherein the video beat locations are computed at least in part by:
computing a plurality of optical flow magnitudes of respective training frame pairs included in the training input video; and
computing the video beat locations within the training input video based at least in part on the optical flow magnitudes.

4. The computing system of claim 3, wherein the video beat locations are local maxima of the optical flow magnitudes.

5. The computing system of claim 2, wherein the one or more processing devices are configured to compute the video-music alignment weighting factor at least in part by determining whether, for each of the video beat locations, the training background music includes a music beat location within a predefined temporal distance of that video beat location.

6. The computing system of claim 2, wherein the one or more processing devices are configured to compute the music beat locations at least in part by:
processing the training background music at a pretrained music tokenizer model to obtain a plurality of training music tokens; and
performing onset detection on the training music tokens to identify the music beat locations.

7. The computing system of claim 1, wherein the video-music contrastive loss term is computed between:
aggregated video representations computed by applying mean pooling to respective training video feature tensors computed from the training input videos; and
aggregated music representations computed by applying mean pooling to estimated music tokens predicted at the video-to-music machine learning model.

8. The computing system of claim 1, wherein:
the video encoder includes a plurality of spatial downsampling blocks; and
at each of the spatial downsampling blocks, the one or more processing devices are configured to spatially downscale a respective intermediate video representation computed at the video encoder.

9. The computing system of claim 8, wherein the spatial downsampling blocks are interspersed among a plurality of transformer blocks.

10. The computing system of claim 1, wherein the autoregressive decoder includes a plurality of causal attention blocks alternating with a plurality of multi-head attention blocks.

11. A method for use with a computing system, the method comprising:
receiving an input video including a plurality of frames;
at a video-to-music machine learning model including a video encoder and an autoregressive decoder:
computing a plurality of video feature tensors at the video encoder based at least in part on the input video; and
autoregressively generating a plurality of music tokens at the autoregressive decoder based at least in part on the video feature tensors, wherein the video-to-music machine learning model has been trained using:
a training data set including a plurality of training input pairs that each include a training input video and respective training background music; and
a loss function including a video-music contrastive loss term and an autoregressive loss term;
converting the music tokens into background music associated with the input video; and
outputting the background music.

12. The method of claim 11, wherein the autoregressive loss term includes a video-music alignment weighting factor that is computed for each of the training input pairs at least in part by:
computing a plurality of music beat locations within the training background music;
computing a plurality of video beat locations within the training input video; and
computing the video-music alignment weighting factor based at least in part on the music beat locations and the video beat locations.

13. The method of claim 12, wherein computing the video beat locations includes:
computing a plurality of optical flow magnitudes of respective training frame pairs included in the training input video; and
computing the video beat locations within the training input video based at least in part on the optical flow magnitudes.

14. The method of claim 13, wherein the video beat locations are local maxima of the optical flow magnitudes.

15. The method of claim 12, wherein computing the video-music alignment weighting factor includes determining whether, for each of the video beat locations, the training background music includes a music beat location within a predefined temporal distance of that video beat location.

16. The method of claim 12, wherein computing the music beat locations includes:
processing the training background music at a pretrained music tokenizer model to obtain a plurality of training music tokens; and
performing onset detection on the training music tokens to identify the music beat locations.

17. The method of claim 11, wherein the video-music contrastive loss term is computed between:
aggregated video representations computed by applying mean pooling to respective training video feature tensors computed from the training input videos; and
aggregated music representations computed by applying mean pooling to estimated music tokens predicted at the video-to-music machine learning model.

18. The method of claim 11, wherein:
the video encoder includes a plurality of spatial downsampling blocks; and
at each of the spatial downsampling blocks, the method further comprises spatially downscaling a respective intermediate video representation computed at the video encoder.

19. The method of claim 11, wherein the autoregressive decoder includes a plurality of causal attention blocks alternating with a plurality of multi-head attention blocks.

20. A computing system comprising:
one or more processing devices configured to train a video-to-music machine learning model, wherein:
the video-to-music machine learning model includes a video encoder and an autoregressive decoder;
the video-to-music machine learning model is trained using:
a training data set including a plurality of training input pairs that each include a training input video and respective training background music; and
a loss function including a video-music contrastive loss term and an autoregressive loss term;
the autoregressive loss term includes a video-music alignment weighting factor that is computed for each of the training input pairs at least in part by:
computing a plurality of music beat locations within the training background music;
computing a plurality of video beat locations within the training input video; and
computing the video-music alignment weighting factor based at least in part on the music beat locations and the video beat locations; and
the video-music contrastive loss term is computed between:
aggregated video representations computed by applying mean pooling to respective training video feature tensors computed from the training input videos; and
aggregated music representations computed by applying mean pooling to estimated music tokens predicted at the video-to-music machine learning model.
